(19) United States
(12) Patent Application Publication
(10) Pub. No.: US 2017/0308867 A1
(43) Pub. Date: Oct. 26, 2017

(54) APPLICATION PROGRAM PROVIDING STUDENT ATHLETE SPORTING EVENT CALENDARING AND PLAYER INFORMATION

(71) Applicant: Lydia Knoll, Noblesville, IN (US)

(72) Inventor: Lydia Knoll, Noblesville, IN (US)

(21) Appl. No.: 15/495,493

(22) Filed: Apr. 24, 2017

Related U.S. Application Data
(60) Provisional application No. 62/326,422, filed on Apr. 22, 2016.

(51) Int. Cl. G06Q 10/10; G06Q 50/00; G06F 3/0482

(52) U.S. Cl. CPC G06Q 10/1095; G06F 3/0482; G06Q 50/01

(57) ABSTRACT

The present disclosure provides a method that includes providing, by a computing device, a user interface viewable on a display of the computing device, the user interface being configured to receive data corresponding to one or more high school athletic events; providing, via the user interface, data to a first application stored in a memory of the computing device, the data corresponding to one of a high school athletic event, an athlete associated with the high school athletic event, and a characteristic of the athlete; accessing, via the user interface, a second application that uses the data provided to the first application, the second application being stored in the memory of the computing device; accessing, via the user interface and the second application, data associated with the one or more high school athletic events, the data indicating one or more characteristics of the athlete and indicating a plurality of characteristics corresponding to the high school athletic event.

### RELATED APPLICATIONS

This application is related to U.S. Provisional Application Ser. No. 62/326,422, filed on Apr. 22, 2016, and titled APPLICATION PROGRAM PROVIDING STUDENT ATHLETE SPORTING EVENT CALENDARING AND PLAYER INFORMATION, the entire enclosure of which is hereby incorporated herein by reference.

### FIELD OF THE DISCLOSURE

The present disclosure generally relates to an application program providing information regarding student athletic events, and more specifically to an application program directed generally toward high school sports wherein the application is configured to calendar a variety of sporting events, provide real-time sports event scoring information, integrate with social media, and provide real-time player metrics.

### BACKGROUND OF THE DISCLOSURE

Student athletes participate in a variety of sporting events such as football, basketball, baseball, soccer, volley ball, swimming, golf and lacrosse. A multitude of existing software applications accessible on laptop and mobile computing devices provide information relating generally only to collegiate and professional sporting events. As is generally known, the aforementioned sports are played by student athletes engaged in academic study at both the collegiate and high school levels. Avid fans and consumers of collegiate sports may also desire an application program configured to provide, for example, comprehensive user specific sporting event calendaring and detailed player information for sporting events occurring at the high school level. Additionally, with the popularity of social media platforms such as Facebook® and Twitter®, fans and consumers of student athletics may further desire, for example, a real time “tweeting” function integrated within the functionality of an exemplary application program. Hence, a need exists for an application program that provides student athlete sporting event calendaring, player information and social media integration for high schools in various geographic regions.

### SUMMARY OF THE DISCLOSURE

In one embodiment of the present disclosure, a method is disclosed which includes providing, by a computing device, a user interface viewable on a display of the computing device, the user interface being configured to receive data corresponding to one or more high school athletic events; providing, via the user interface, data to a first application stored in a memory of the computing device, the data corresponding to one of a high school athletic event, an athlete associated with the high school athletic event, and a characteristic of the athlete; accessing, via the user interface, a second application that uses the data provided to the first application, the second application being stored in the memory of the computing device; accessing, via the user interface and the second application, data associated with the one or more high school athletic events, the data indicating one or more characteristics of the athlete and indicating a plurality of characteristics corresponding to the high school athletic event.

In one aspect of this embodiment, the first application is an administrator program and the second application is a student user program. In another aspect of this embodiment, the one or more characteristics of the athlete includes the name of the athlete, an identifying number associated with the athlete, a position played by the athlete, and a high school academic year of the athlete. In yet another aspect of this embodiment, the plurality of characteristics of the high school athletic event includes a real-time score associated with the high school athletic event, a location of the high school athletic event and an outcome of the high school athletic event.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The above-mentioned and other features of this disclosure and the manner of obtaining them will become more apparent and the disclosure itself will be better understood by reference to the following description of embodiments of the present disclosure taken in conjunction with the accompanying drawings, wherein:

FIG. 1 shows a user login screen for a sporting event application program according to an embodiment of the present disclosure;

FIG. 2 shows an exemplary school selection screen for the sporting event application program of FIG. 1 according to an embodiment of the present disclosure;

FIG. 3 shows an exemplary sports season selection screen for the sporting event application program of FIG. 1 according to an embodiment of the present disclosure;

FIG. 4 shows an exemplary competing school selection screen for the sporting event application program of FIG. 1 according to an embodiment of the present disclosure;

FIG. 5 shows another exemplary school selection screen for the sporting event application program of FIG. 1 according to an embodiment of the present disclosure;

FIG. 6 shows an exemplary single sport selection screen for the sporting event application program of FIG. 1 according to an embodiment of the present disclosure;

FIG. 7 shows an exemplary multiple sports selection screen for the sporting event application program of FIG. 1 according to an embodiment of the present disclosure;

FIG. 8 shows an exemplary school sporting match screen for the sporting event application program of FIG. 1 according to an embodiment of the present disclosure;

FIG. 9 shows an exemplary match input screen with at least two input options for the sporting event application program of FIG. 1 according to an embodiment of the present disclosure;

FIG. 10 shows an exemplary single match information input screen for the sporting event application program of FIG. 1 according to an embodiment of the present disclosure;

FIG. 11 shows an exemplary multiple match information input screen for the sporting event application program of FIG. 1 according to an embodiment of the present disclosure;

FIG. 12 shows an exemplary roster screen including individual player information for the sporting event application program of FIG. 1 according to an embodiment of the present disclosure;

FIG. 13 shows an exemplary player information input screen for the sporting event application program of FIG. 1 according to an embodiment of the present disclosure;

FIG. 14 shows an exemplary text entry screen for inputting player information within the sporting event application program of FIG. 1 according to an embodiment of the present disclosure;

FIG. 15 shows an exemplary user specific home screen for the sporting event application program of FIG. 1 according to an embodiment of the present disclosure;

FIG. 16 shows an exemplary external application access request screen for the sporting event application program of FIG. 1 according to an embodiment of the present disclosure;

FIG. 17 shows an exemplary user specific school sporting schedule screen for the sporting event application program of FIG. 1 according to an embodiment of the present disclosure;

FIG. 18 shows an exemplary user specific roster screen including individual player information for the sporting event application program of FIG. 1 according to an embodiment of the present disclosure;

FIG. 19 shows an exemplary local application access request screen for the sporting event application program of FIG. 1 according to an embodiment of the present disclosure;

FIG. 20 shows an exemplary student specific social media integration screen for the sporting event application program of FIG. 1 according to an embodiment of the present disclosure; and

FIG. 21 shows a block diagram of an exemplary network for exchanging data communications between at least one computing device and at least one server according to an embodiment of the present disclosure.

### DETAILED DESCRIPTION OF EMBODIMENTS

The embodiments disclosed herein are not intended to be exhaustive or to limit the disclosure to the precise forms disclosed in the following detailed description. Rather, the embodiments were chosen and described so that others skilled in the art may utilize their teachings. The following description is merely exemplary in nature and is in no way intended to limit the disclosure, its application, or uses. As used herein, the phrase at least one of A, B, and C should be construed to mean a logical (A or B or C), using a non-exclusive logical OR. It should be understood that steps within a method may be executed in a different order without altering the principles of the present disclosure. As used herein, the term computing device may refer to an Application Specific Integrated Circuit (ASIC), an electronic circuit, a processor (shared, dedicated, or group) and memory that execute one or more software or firmware programs, a combinational logic circuit, and/or other suitable components that provide the described functionality.

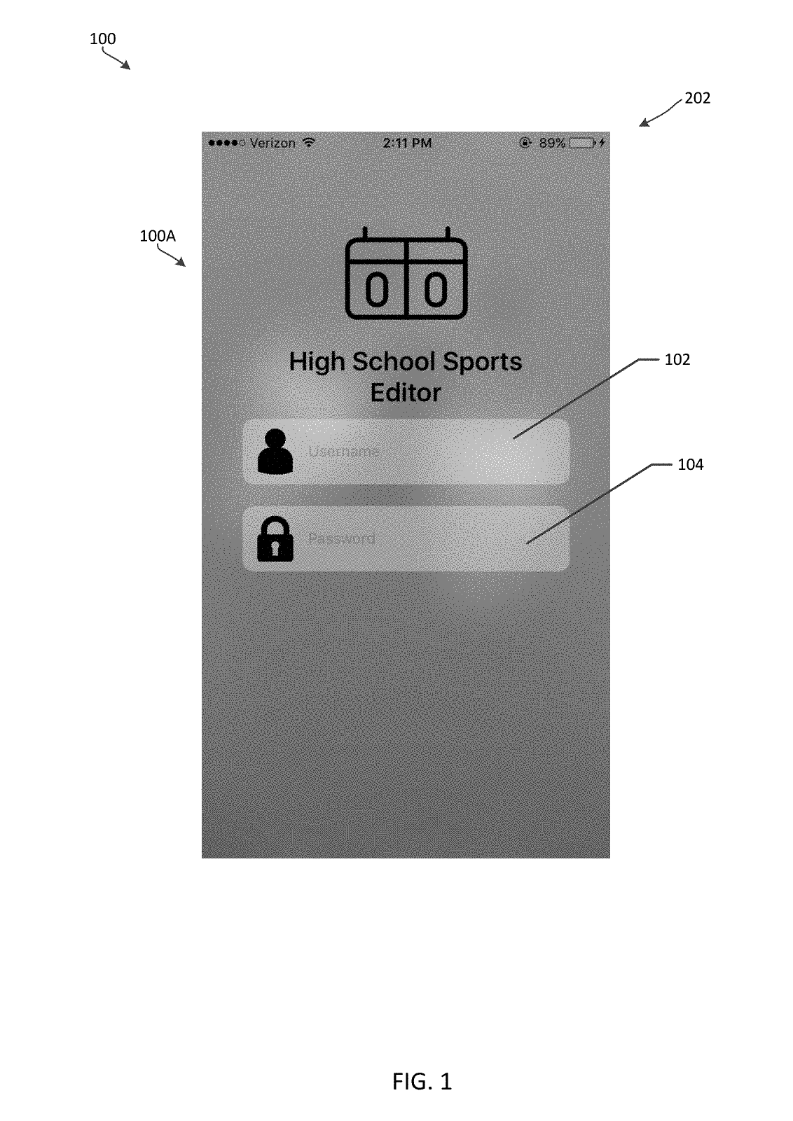

The illustrative embodiment of FIG. 1 shows a user login screen 202 for a sports event application program 100 (hereinafter “program 100”) according to an embodiment of the present disclosure. As described in further detail herein below, program 100 includes an editor application program 100A and a student application program 100B. Program 100A generally includes user login screen 202 which includes username input 102 and password input 104. Username input 102 and password input 104 are conventional user input features within an exemplary application program accessible via a conventional computing device such as a smartphone, a tablet device, or a laptop computer. In various embodiments of the present disclosure, username input 102 and password input 104 are configured to receive and display a plurality of alphanumeric characters which may inputted to the conventional computing device via, for example, a digital keyboard. As is known in the art, once a user inputs certain access credentials in the form of a username and password combination, the computing device will authenticate the user inputted credentials and the user will then be allowed to access and utilize the plurality of features within program 100. Additionally, in various embodiments, the plurality of screens associated with program 100 are representative of viewable features and functions accessible on a display screen of an exemplary computing device having executable code for program 100 stored within device memory.

As is known in the art, the exemplary computing device generally includes at least one logic device (e.g., logic circuitry)/processor and memory. In one embodiment, the computing device includes a display screen configured to display a user interface through which a user may view and utilize the various features and functions of program 100. In one embodiment, the display screen may be a touch screen display that allows users to interact with the computing device and program 100 by touching areas on the display screen that correspond to a particular function viewable via the user interface of program 100. In one embodiment, the logic device/processor of the computing device is a microprocessor that includes one or more control algorithms or logic that is generally operable to control and manage the overall operation of the computing device. In one embodiment, the processor may include one or more microprocessors, microcontrollers, digital signal processors (DSPs), combinations thereof and/or such other devices known to those having ordinary skill in the art that may be configured to process one or more data and/or parameter signals to provide one or more control signals. In one embodiment, the memory includes random access memory (RAM), dynamic random access memory (DRAM), and/or read only memory (ROM) or equivalents thereof, that store data and programs that may be executed by the processor.

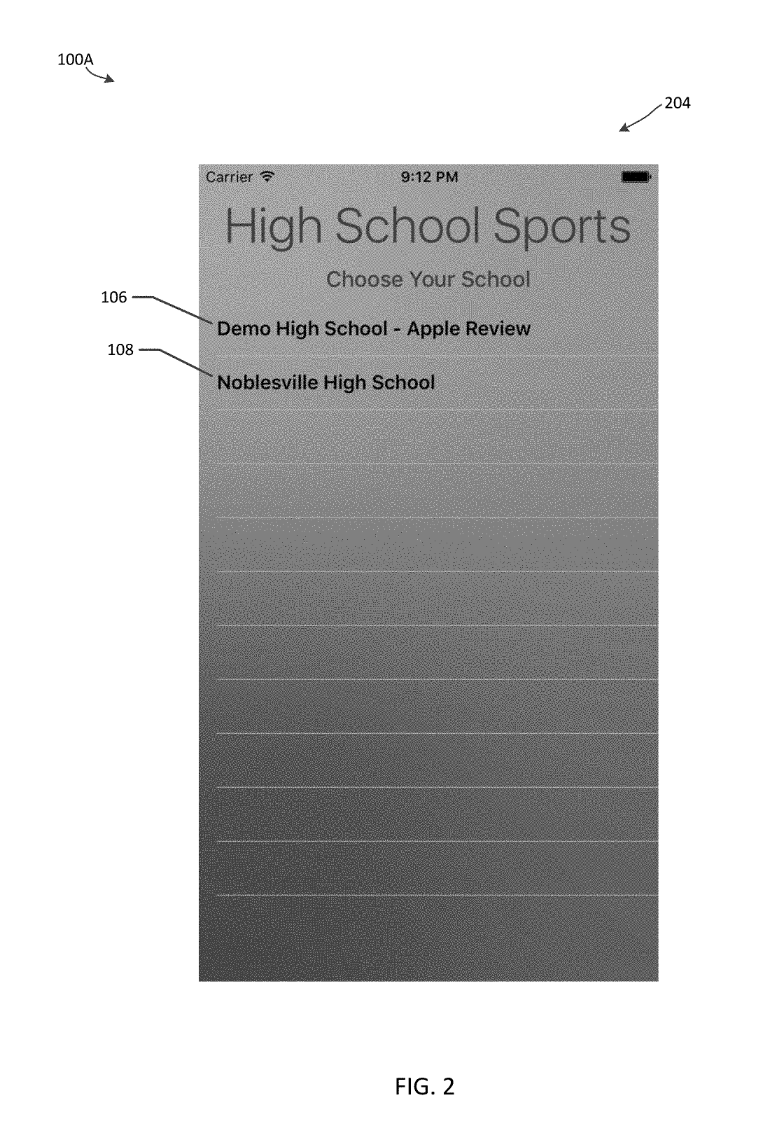

The illustrative embodiment of FIG. 2 shows an exemplary school selection screen 204 for program 100 according to an embodiment of the present disclosure. School selection screen 204 includes selectable feature 106 corresponding to a demo function integrated within program 100 and selectable feature 108 corresponding to an exemplary high school. As discussed briefly above, program 100 is generally configured to provide student athlete sporting event calendaring, player information and social media integration for high schools in various geographic regions. In one embodiment, program 100 provides sporting event calendaring, sporting event scoring and player information for a plurality of high schools in an exemplary state such as Indiana. In another embodiment, program 100 enables one or more students to communicate via social media application functionality integrated within program 100 (e.g., see description of program 100B herein below). In one aspect of this embodiment, social media application functions associated with, for example, Twitter® are integrated within program 100. This social media application function enables one or more student users to share text based communications (e.g. tweets, text messages, etc.) and digital image files with other student users that also have access to program 100.

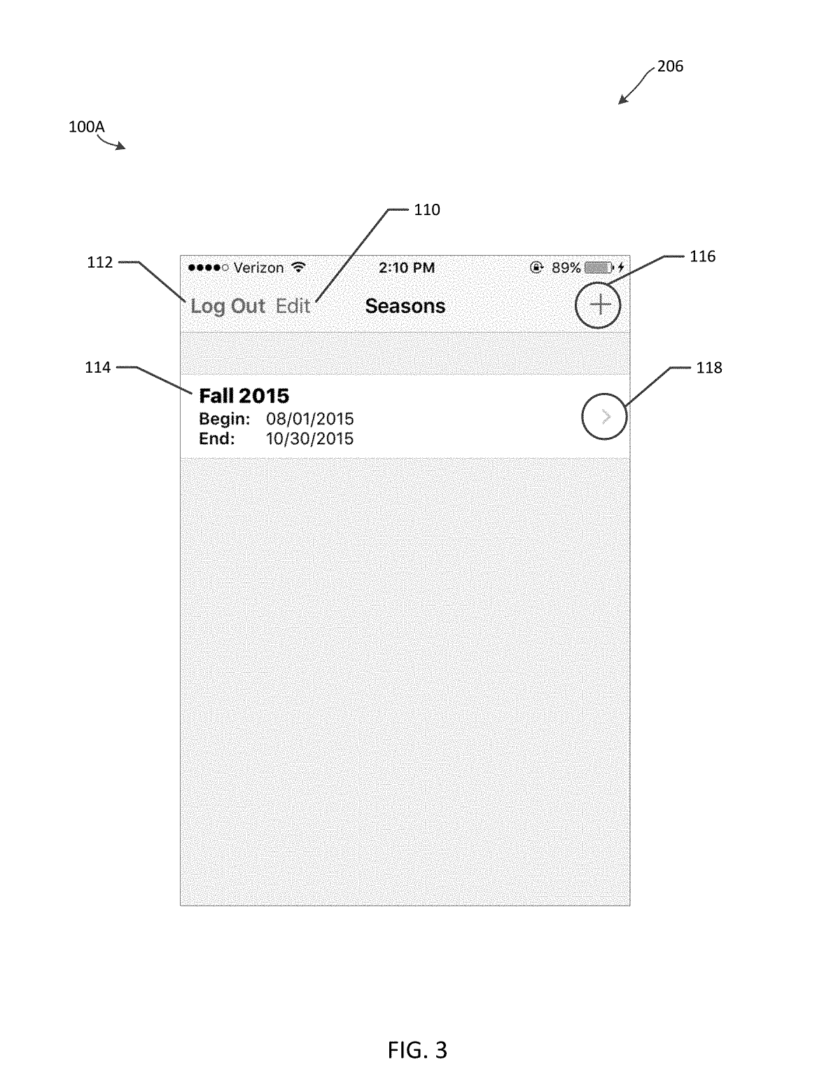

FIG. 3 shows an exemplary sports season selection screen 206 for program 100 according to an embodiment of the present disclosure. Sports season selection screen 206 includes season edit feature 110, program logout feature 112, sports season 114, add season feature 116, and advance feature 118. As discussed briefly above, program 100 includes an editor application program 100A (hereinafter “program 100A”) and a student application program 100B (hereinafter “program 100B”). Program 100A enables an exemplary system or user administrator to edit program 100 by, for example, adding and/or removing one or more features or functions that are viewable and/or accessible within program 100B. Hence, program 100B is generally configured such that a non-administrator user (e.g. a student user) can only view and access those program features and functions that are enabled by program 100A. As shown in various illustrative embodiments of the present disclosure, program 100 generally includes user interface features having substantial similarity to, for example, user interface features of an iPhone. The present disclosure therefore contemplates that one of ordinary skill in the art as well as an ordinary cellular/smart phone user will have general familiarity with, for example, edit feature 110, logout feature 112, add feature 116, and advance feature 118.

As shown in the illustrative embodiment of FIG. 3, season selection screen 206 of program 100A includes various features and functions which allow an administrator user (hereinafter “AU”) to add one or more sports seasons to program 100B. In one embodiment, the AU adds the one or more sports seasons by tapping/touching the area of an exemplary touch screen display where add season feature 116 is displayed. In this embodiment, the user may utilize feature 116 to add an exemplary season such as a Fall 2015 Football season having a season begin date of Aug. 1, 2015 and a season end date of Oct. 30, 2015. In alternative embodiments, the AU may utilize feature 116 to add additional sports seasons such as, for example, a Fall 2015 Basketball season, a Spring 2015 soccer season, and a Summer 2016 Baseball season. Accordingly, a plurality of sports seasons may be added to program 100 via program 100A wherein each sports season includes a begin date and an end date as desired by the AU. In one embodiment, once an exemplary sports season is added, season edit feature 110 allows the AU to change, modify or revise the information entered for a particular season. For example, edit 110 allows an AU to revise the most recent begin date and/or end date entered for a particular season. As described in more detail below, tapping or engaging advance feature 118 causes program 100A to transition or move to another screen associated with program 100A. In the illustrative embodiment of FIG. 3, engaging advance feature 118 causes program 100A to transition to, for example, a school selection screen whereby the AU can associate the one or more added sports seasons to a particular competing high school.

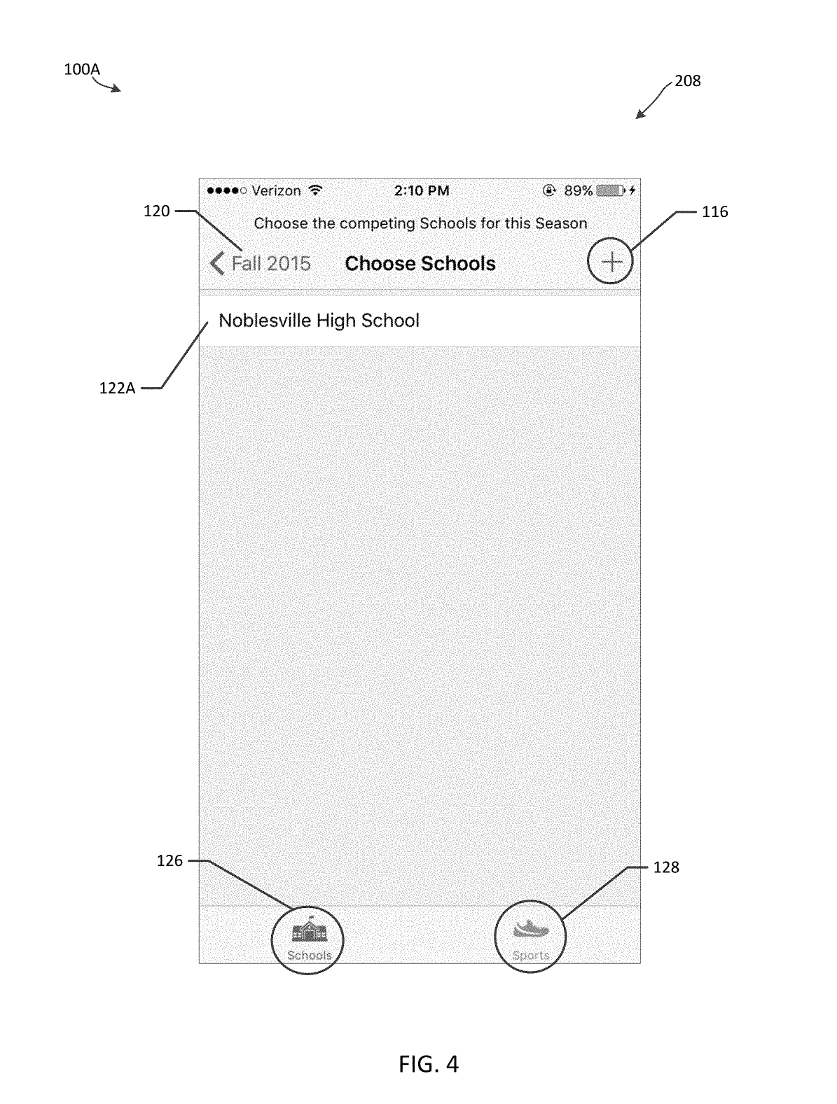

FIG. 4 shows an exemplary school selection screen 208 for program 100 according to an embodiment of the present disclosure. Screen 208 includes add school feature 116, sports season selection 120, school list 122A, schools menu 126, and sports menu 128. As indicated above, in one embodiment, an AU accesses screen 208 by selecting/tapping edit feature 110 and then selecting/tapping advance feature 118 while screen 206 is displayed on the computing device. Hence, school selection screen 208 is directly associated with sports selection screen 206 in that screen 208 allows an AU to edit a particular sports season 114 by choosing one or more competing schools for that particular sports season 114. As shown in the illustrative embodiment of FIG. 4, school selection screen 208 of program 100A includes various features and functions which allow an AU to add and/or choose one or more competing schools to and/or for use within program 100B. In one embodiment, the AU adds the one or more schools by tapping/touching the area of an exemplary touch screen display where add feature 116 is displayed. In this embodiment, the AU may utilize feature 116 to add an exemplary high school such as Noblesville High School, Carmel High School or Zionsville High School. Accordingly, a plurality of high schools may be added to program 100 via program 100A wherein each high school is viewable in school list 122A and associated with particular sports seasons selected via selection screen 206. Once an exemplary high school is added, season selection 120 allows the AU to transition back to sports season selection screen 206 and associate additional high schools with additional sports seasons. Schools menu 126 allows a user to view, add, or select/choose one or more high schools for use within program 100B. Sports menu 128 allows a user to view, add, or select/choose one or more sports activities for use within program 100B.

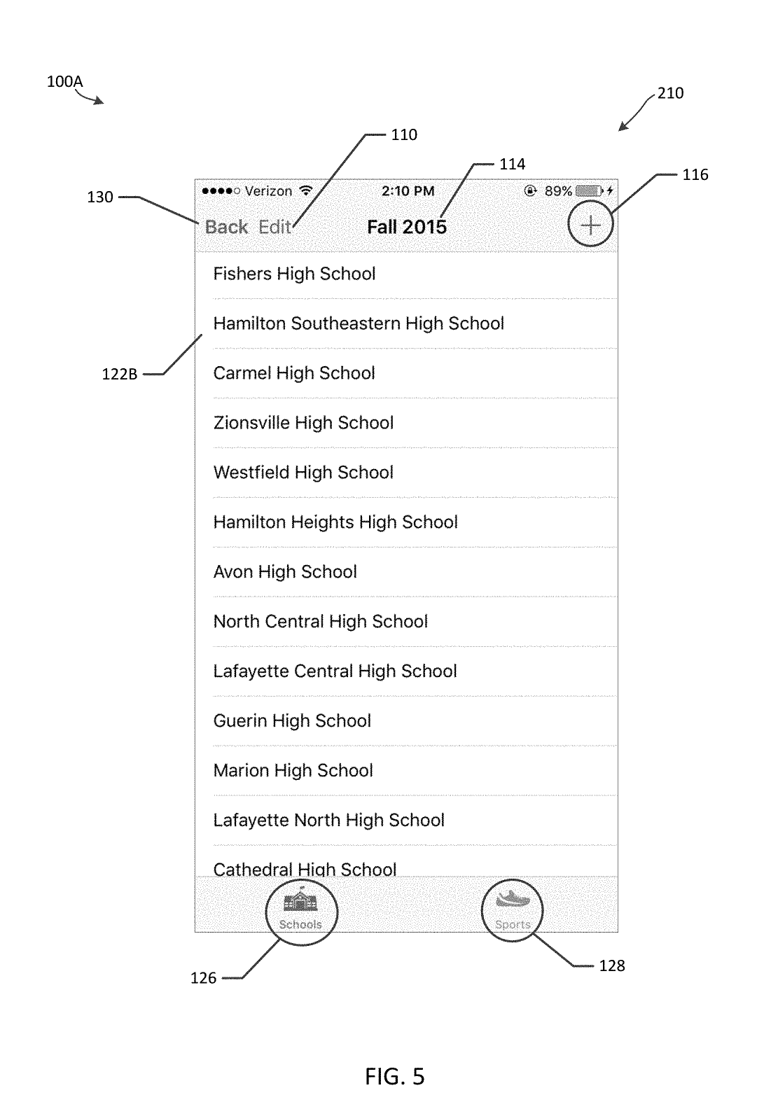

FIG. 5 shows another exemplary school selection screen 210 for program 100 according to an embodiment of the present disclosure. Screen 210 includes edit feature 110, sports season 114, back feature 130, add school feature 116, school list 122B, schools menu 206, and sports menu 128. School selection screen 210 includes some of the same functions and features as shown for screen 208. In one embodiment, an AU accesses screen 210 by selecting/tapping add school feature 116 while screen 208 is displayed on the computing device. Hence, much like screen 208, school selection screen 210 is also directly associated with sports selection screen 206 in that screen 210 also allows an AU to edit a particular sports season 114 by viewing and/or adding one or more competing schools for that particular sports season. As shown in the illustrative embodiment of FIG. 5, school selection screen 210 of program 100A allows an AU to add, via feature 116, one or more competing high schools from the plurality of school options shown in list 122B. Screen 210 further allows an AU to edit, via feature 110, the names of the one or more schools viewable in school list 122B. Once the AU completes the step of adding high schools or editing the names of existing high schools, the AU selects/taps back feature 130 and transitions/returns to screen 206. In the embodiment of FIG. 5, school list 122B is substantially similar to school list 122A, except that list 122B shows the plurality of high schools added via screen 208. Hence, the plurality of high schools shown in school list 122B are associated with the Fall 2015 sports season 114 shown on season selection screen 206.

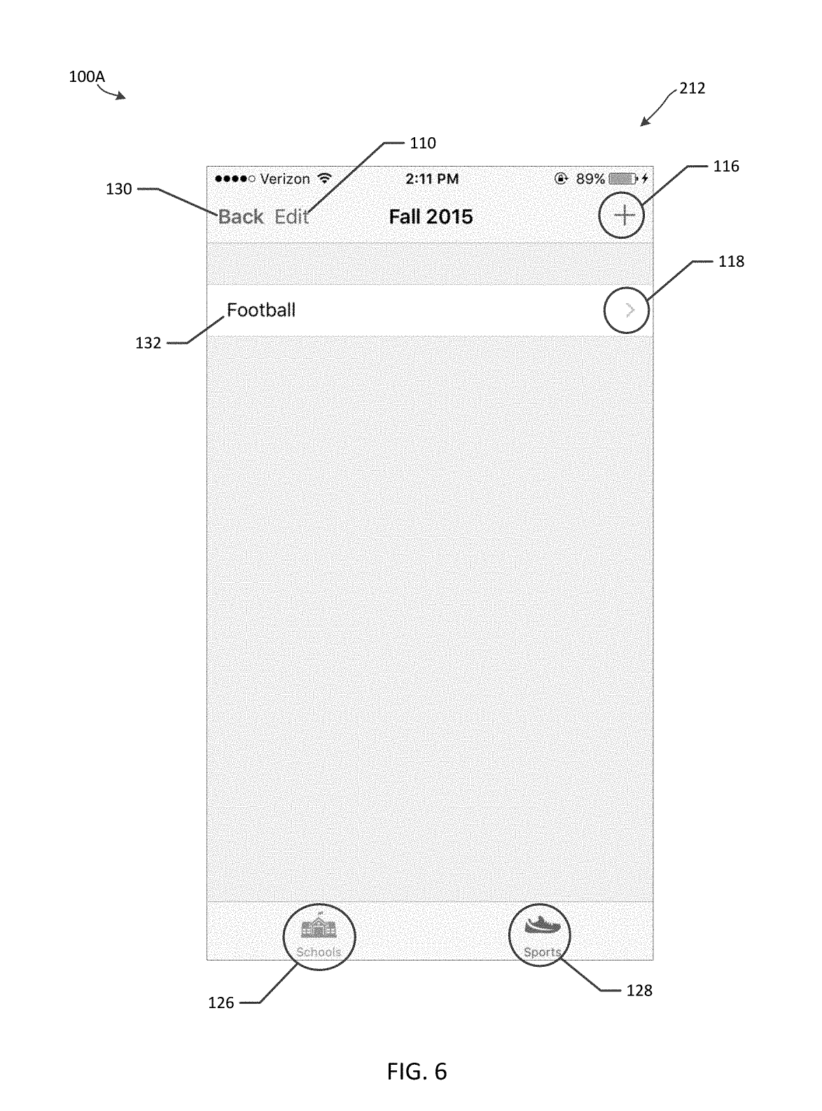

FIG. 6 shows an exemplary single sport selection screen 212 for program 100 according to an embodiment of the present disclosure. Screen 212 includes edit feature 110, add feature 116, advance feature 118 and back feature 130. Screen 212 further includes sport 132, schools 126, and sports 128. Single sport selection screen 212 includes substantially the same functions and features as shown for screen 210. In one embodiment, an AU accesses screen 212 by selecting/tapping the program icon corresponding to sports 128 while screen 210 is displayed on the computing device. Likewise, in one aspect of this embodiment, an AU may also access school selection screen 210 by selecting/tapping the program icon corresponding to schools 126 while screen 212 is displayed on the computing device. Hence, much like screen 210, single sport selection screen 212 is also directly associated with sports selection screen 206 in that screen 212 also allows an AU to edit a particular sports season 114 by adding and/or deleting one or more sports 132 for that particular sports season 114. As disclosed above with regard to FIG. 5, screen 212 of program 100A allows an AU to add, via feature 116, one or more sports 132. Screen 212 further allows an AU to edit, via feature 110, the names of the one or more sports 132 viewable within screen 212. Once the AU completes the step of adding sports 132 or editing the names of existing sports, the AU selects/taps back feature 130 and transitions/returns to screen 206. Hence, the sport 132 shown within screen 212 are associated with the Fall 2015 sports season 114 shown on season selection screen 206 and indicates, for example, the one or more sports programs that are affiliated with a particular school(s).

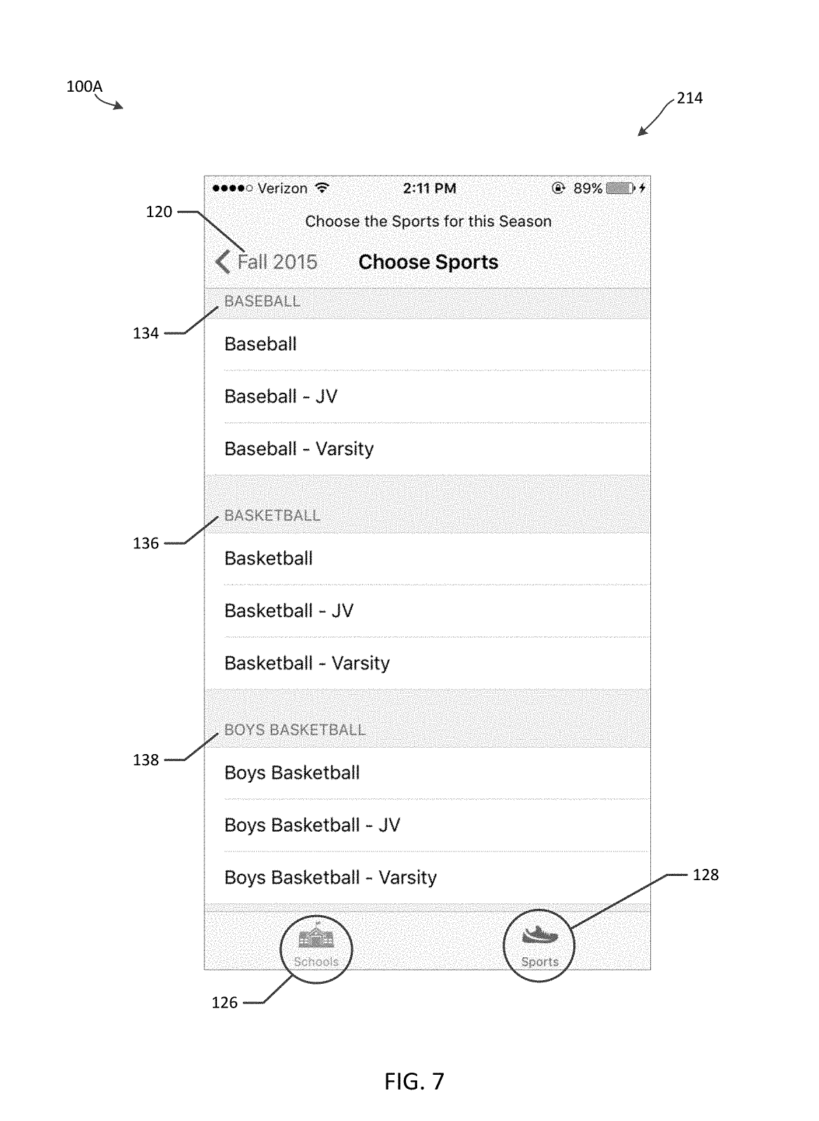

FIG. 7 shows an exemplary multiple sports selection screen 214 for program 100 according to an embodiment of the present disclosure. Screen 214 includes sports season selection 120, first sport 134, second sport 136, third sport 138, schools 126, and sports 128. As discussed above, in one embodiment, an AU accesses screen 214 by at least selecting/tapping edit feature 110 and then selecting/tapping advance feature 118 while screen 206 is displayed on the computing device. Additionally, after selecting feature 118 on screen 206, an AU may further need to select/tap sports 128 in order to access screen 214. Hence, multiple sport selection screen 214 is directly associated with sports selection screen 206 in that screen 214 allows an AU to edit a particular sports season 114 by choosing one or more sports at various competition levels (i.e. varsity, junior varsity (JV)) for that particular sports season 114. As shown in the illustrative embodiment of FIG. 7, screen 214 of program 100A includes a variety of sports and competition levels for use within program 100B. In one embodiment, the AU adds the one or more sports by tapping/touching the area of an exemplary touch screen display where the sport and desired competition level are displayed. In this embodiment, the AU may select, for example, a first sport 134 (e.g. Baseball—JV), a second sport (e.g. Basketball—JV), and a third sport (e.g. Boys Basketball—JV). Accordingly, a plurality of sports may be added to program 100 via program 100A wherein each sport is viewable in screen 212 and associated with particular sports seasons selected via selection screen 206. Once one or more sports are added, season selection 120 allows the AU to transition back to sport selection screen 212 and associate additional sports with an exemplary season such as a Fall 2015 sport season.

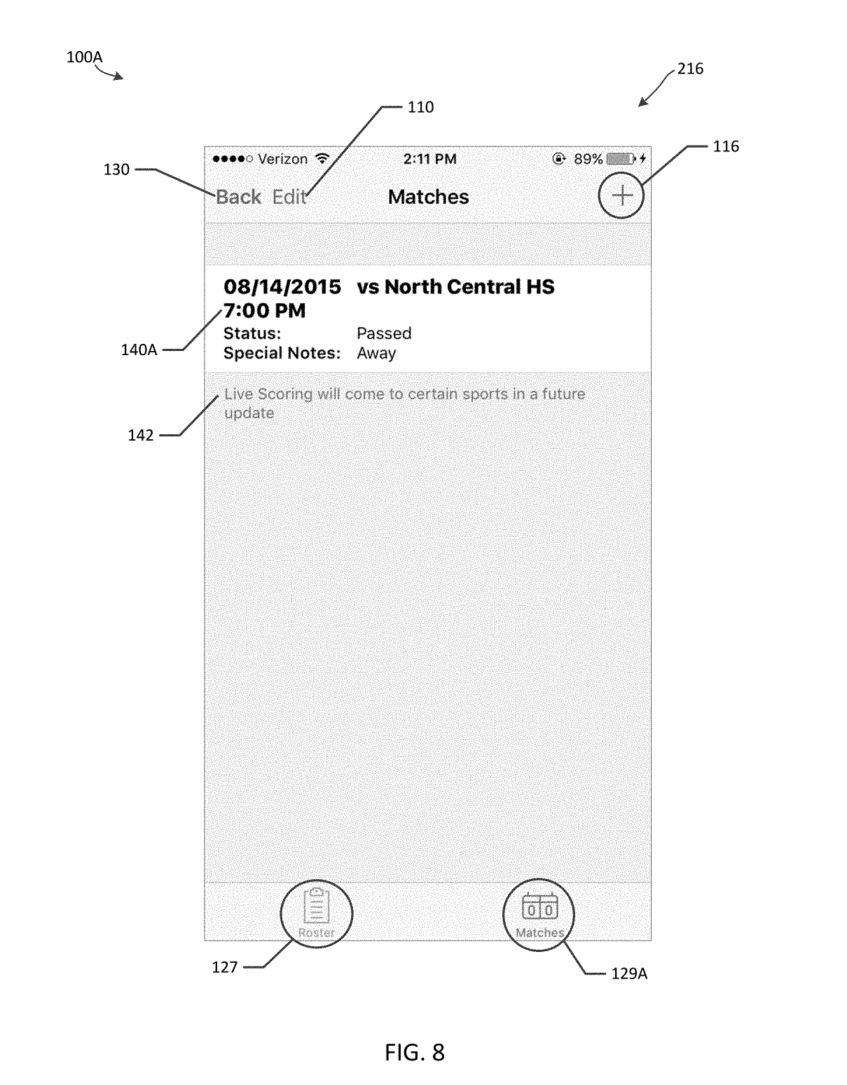

FIG. 8 shows an exemplary school sporting match screen 216 for program 100 according to an embodiment of the present disclosure. Screen 216 includes edit feature 110, add feature 116, back feature 130, match information 140A, scoring section 142, roster 127, and matches 129A. Add feature 116 allows an AU to add one or more matches for a particular sports season 114 and, once added, edit feature 110 allows an AU to edit the one or more matches. In one embodiment, match information 140A includes school opponent (e.g. North Central HS), match start time (e.g. 7:00 PM), match status (e.g. Passed, Upcoming, Now, etc.), match special notes (e.g. Away). In one embodiment, scoring section 142 provides scoring information for one or more matches added to program 100. In one aspect of this embodiment, program 100 is configured to establish a data communications link with an exemplary high school sports webpage for one or more high schools in school list 122B. In this embodiment, program 100 may be configured to receive real-time scoring information for one or more sports matches corresponding to a particular high school added to program 100 via screen 210. As described in more detail below, roster 127 is a conventional player roster that includes individual player (student athlete) information for the two teams engaged in a sporting match. As shown in the illustrative embodiment of FIG. 8, matches 129A shows one or more matches associated with a particular sports season 114. Back feature 130 causes program 100A to transition back to sports selection screen 212. Alternatively, as indicated above, a user may edit a particular sports season by tapping/selecting sports feature 128.

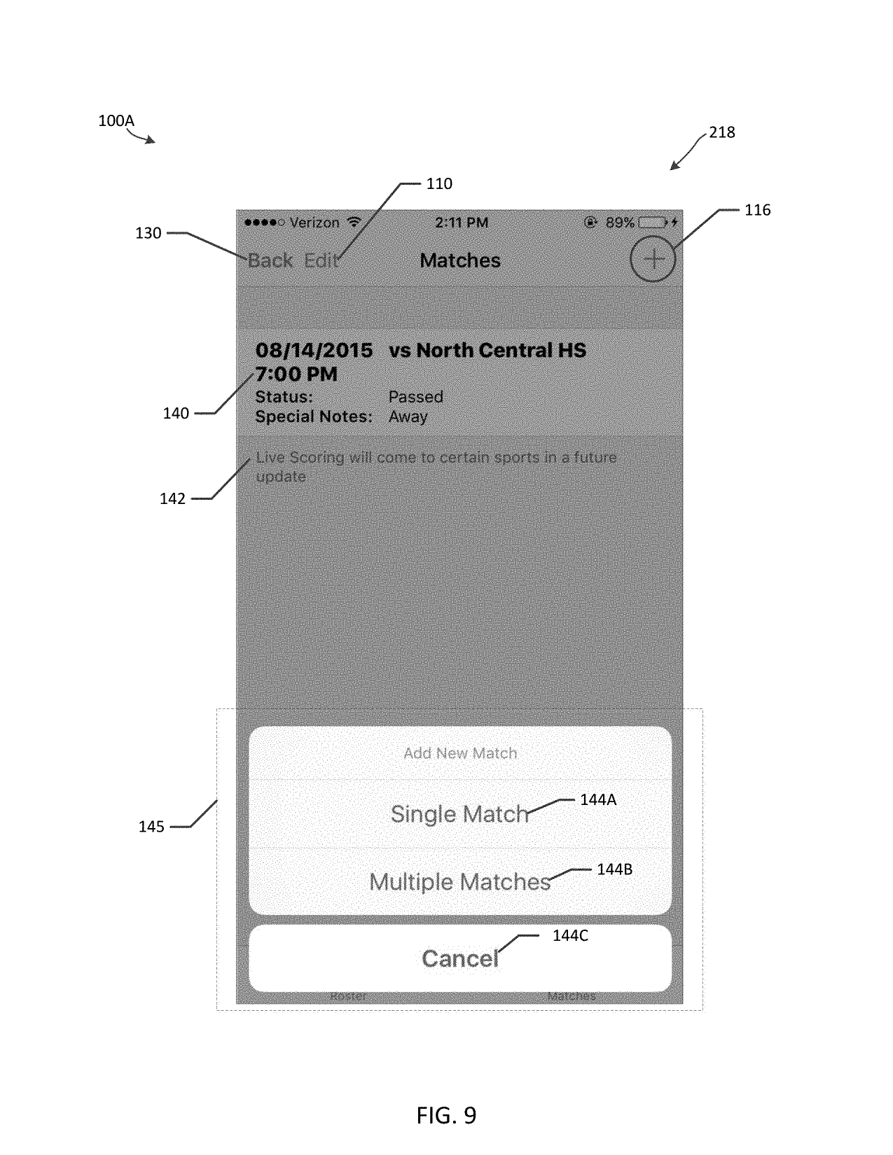

FIG. 9 shows an exemplary match information input screen 218 with at least two input options selectable within program 100 according to an embodiment of the present disclosure. Screen 218 includes add feature 116, edit feature 110, back feature 130, match information 140A, scoring section 142. Screen 218 further includes add match features 145 which includes add single match feature 144A, add multiple matches feature 144B, cancel add match 144C. In one embodiment, add feature 116 causes add match features 145 to be displayed on the user interface of the exemplary computing device. As shown in FIG. 9, an AU can add a single match via feature 144A and add multiple matches via feature 144B. Alternatively, if an AU no longer wishes to add a match after selecting/tapping add feature 116, then the AU may select/tap cancel add match 144C.

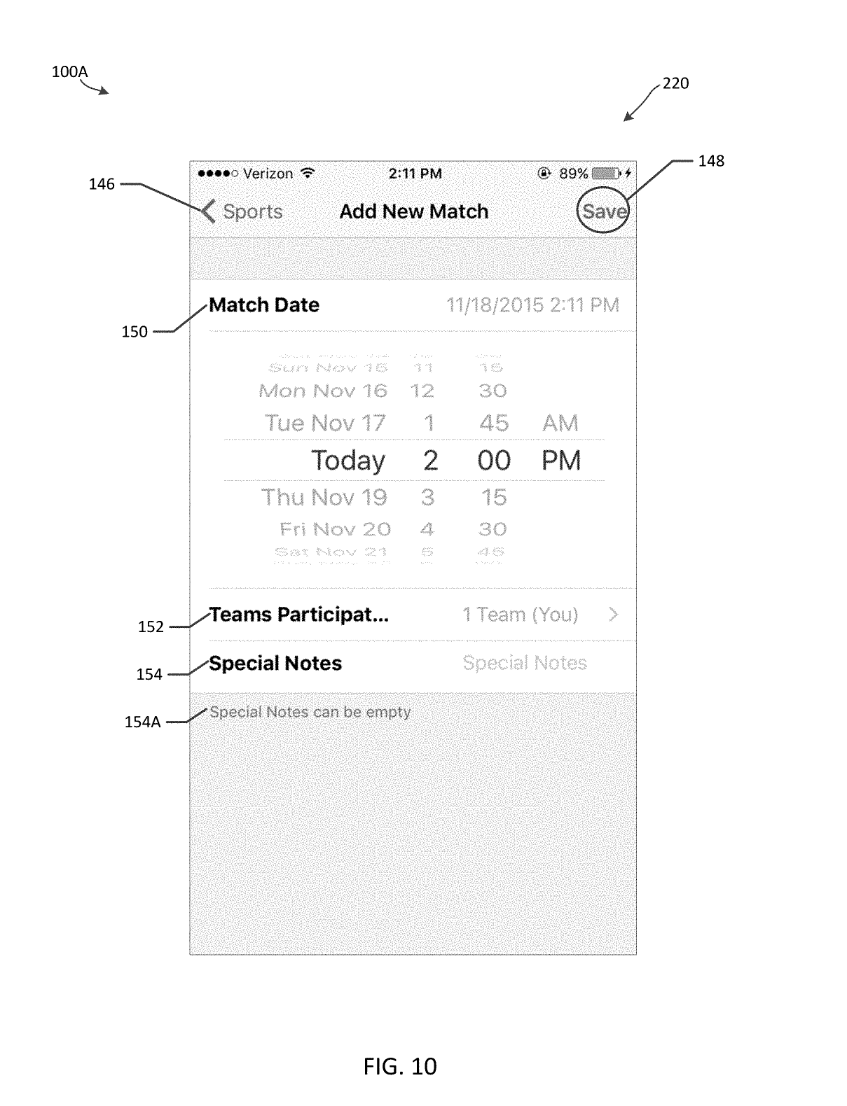

FIG. 10 shows an exemplary single match information input screen 220 for program 100 according to an embodiment of the present disclosure. Screen 220 includes save feature 148, transition feature 146, match date feature 150, team participation feature 152, special notes feature 154, and information section 154A. In one embodiment, an AU accesses screen 220 by selecting/tapping add single match feature 144A. As is generally known, match date feature 150 includes standard date entry information such as calendar date and time for a single sporting match. Feature 152 allows an AU to add the teams participating in a particular sporting match. In one embodiment, tapping/engaging feature 152 causes program 100A to transition back to screen 208 so that an AU may add/select teams participating in a sports match from the list of schools list 122A/B. Additionally, special notes feature 154 allows an AU to input text data indicating special notes or other pertinent information relating to a particular individual match. In one embodiment, program 100A includes information section 154A which may be configured to display messages for one or more student users accessing and using the features of program 100B. In one embodiment, when an AU selects/taps transition feature 146 program 100A transitions to school sporting match screen 216.

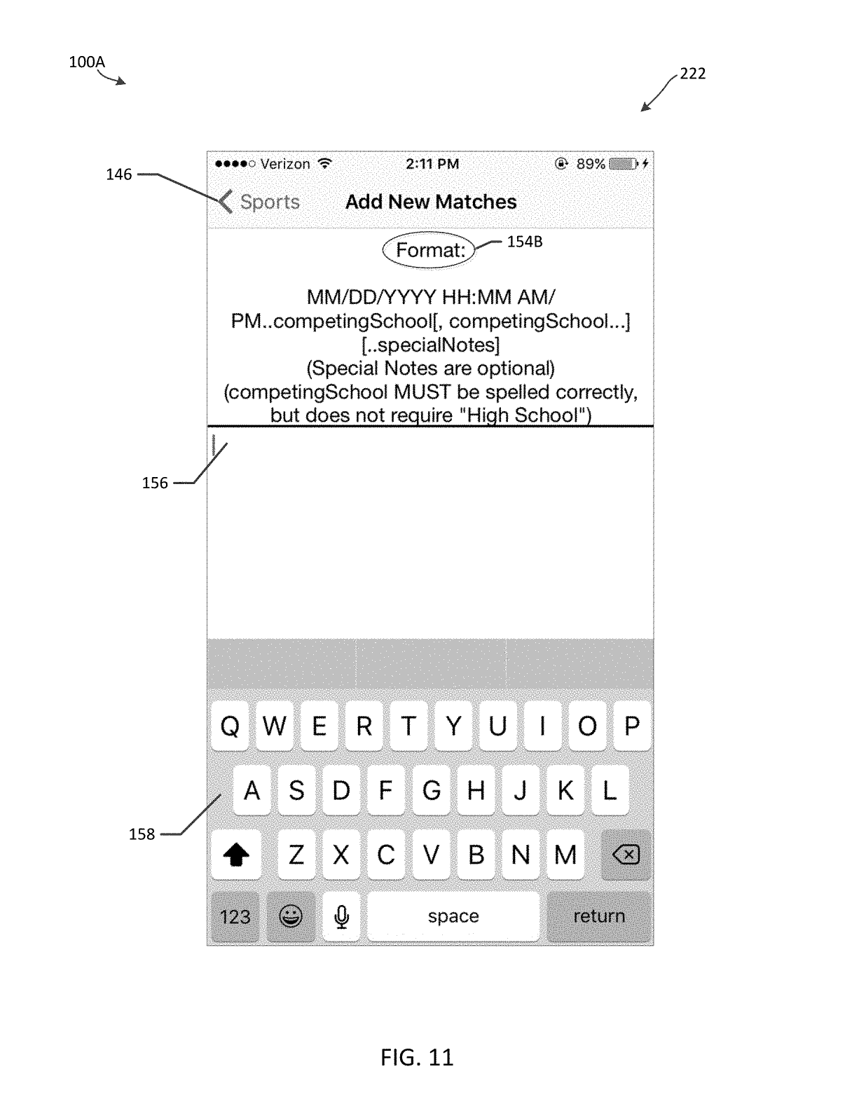

FIG. 11 shows an exemplary multiple match information input screen 222 for program 100 according to an embodiment of the present disclosure. Screen 222 includes transition feature 146, format information 154B, input section 156 and digital keyboard 158. As known by one of ordinary skill, digital keyboard 158 enables an AU to input/enter, via the computing device, data or information (using alphanumeric characters) associated with a plurality of individual sports matches. In one embodiment, an AU accesses screen 222 by selecting/tapping add multiple matches feature 144B. The features of program 100A shown in screen 222 allow mass input of data associated with a plurality of sporting matches. In one embodiment, input section 156 allows an AU to conveniently paste/input a plurality of data associated with multiple matches at once rather than adding each match individually using single match feature 144A shown in the illustrative embodiment of FIG. 10. Format information 154B is an indicator to the AU that includes information indicating the required format the AU must abide by when using the mass input feature associated with input section 156. Tapping/engaging transition feature 146 causes program 100A to transition to match information input screen 216.

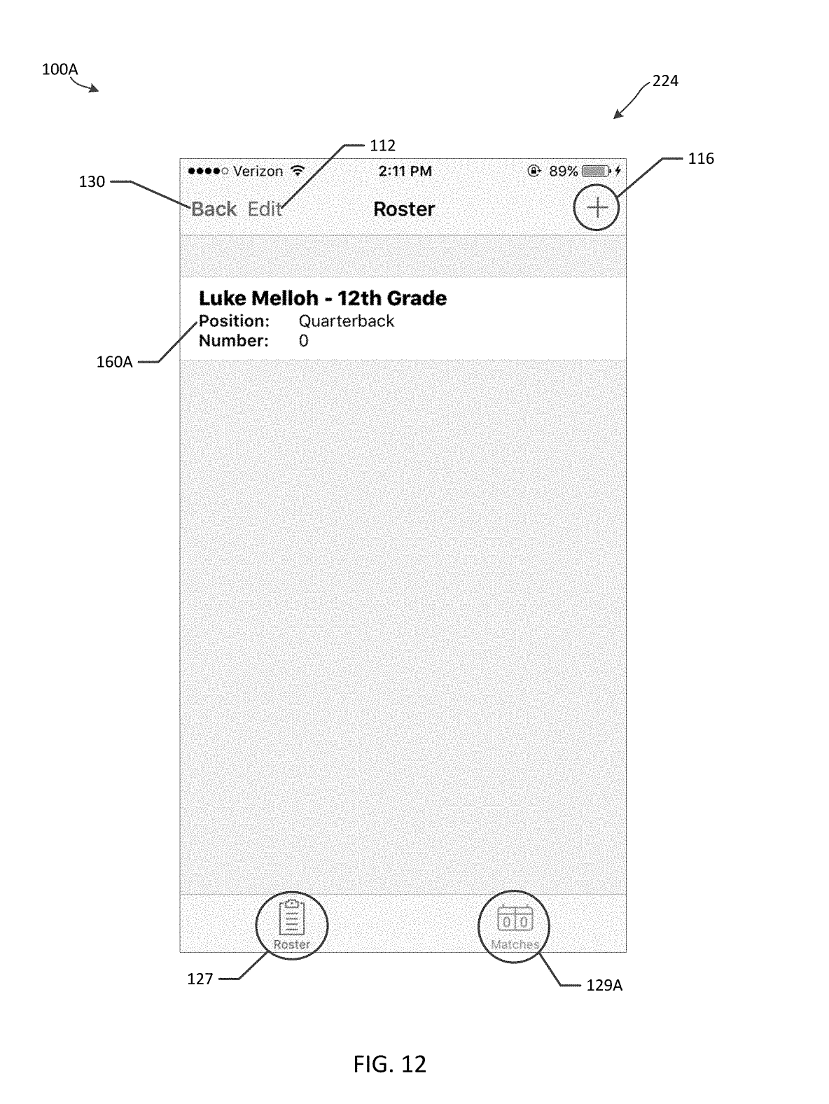

FIG. 12 shows an exemplary roster screen 224 including individual player information viewable within program 100 according to an embodiment of the present disclosure. An AU may access screen 224 by selecting/tapping roster 127 while screen 218 is displayed on the computing device. Screen 224 includes back feature 130, edit feature 112, add feature 116, student athlete/player information 160A, and matches 129A. As shown in the embodiment of FIG. 12, player information 160A includes one or more characteristics of the student athlete such as the name of the athlete, an identifying number associated with the athlete, a sport position played by the athlete, and a high school academic year/grade of the athlete. In various embodiments, the identifying number associated with the athlete corresponds to the number displayed on a team uniform or jersey worn by the athlete when the athlete participates in an exemplary sports match or sporting event. In one embodiment, tapping/engaging matches 129A causes program 100A to transition from screen 224 to match screen 216. Likewise, selecting back feature 130 may also cause program 100A to transition from screen 224 to match screen 216. Add feature 116 allows an AU to add one or more players to a roster associated with a particular high school sports team that will participate in a sports match viewable on screen 216. Moreover, edit feature 112 allows an AU to modify/change the player information and/or one or more characteristics entered for a particular student athlete.

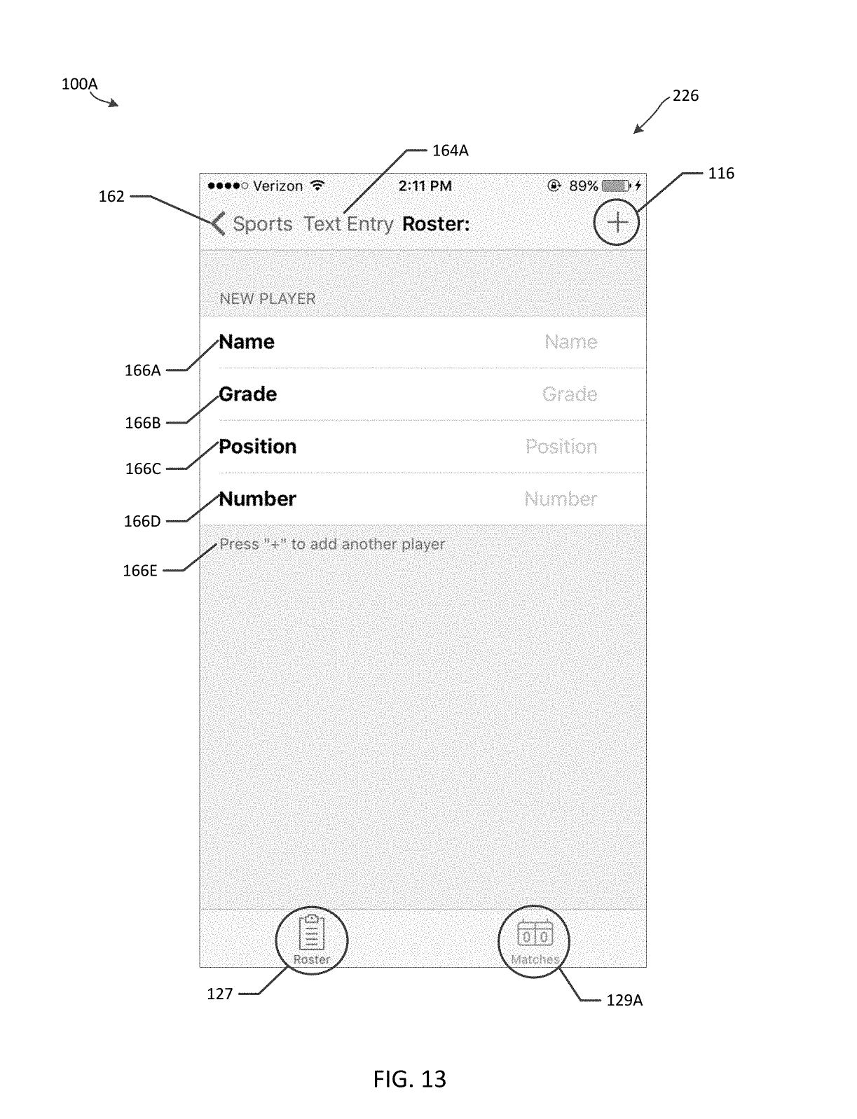

FIG. 13 shows an exemplary player information input screen 226 for program 100 according to an embodiment of the present disclosure. An AU may access screen 226 by tapping/engaging add feature 116 while screen 224 is displayed on the computing device. Screen 226 includes transition feature 162, text entry feature 164A and add feature 116. Screen 226 further includes roster 127, matches 129A, and a plurality of new player input sections (166A-D) that allow an AU to input particular characteristics associated with a student athlete. As shown in the illustrative embodiment of FIG. 13, new player input section 166A allows an AU to input an athlete's name, input section 166B allows the AU to input the athlete's grade or high school academic year/grade, input section 166C allows the AU to input the athlete's player position (e.g., Quarterback, Point Guard, Pitcher, etc.), input section 166D allows the AU to input the athlete's identifying number such as the number displayed on a team uniform or jersey worn by the athlete. Screen 226 also includes an information section 166E that displays text based information indicating that an AU can press/tap/select add feature 116 to add another player and therefore input characteristics associated with that student athlete. As described in more detail below, text entry feature 164A allows an AU to utilize digital keyboard 158 to input information/characteristics relating to the student athlete. In one embodiment, selecting matches 129 while screen 226 is displayed causes program 100A to transition from screen 226 to match screen 216. In another embodiment, selecting roster 127 while screen 226 is displayed causes program 100A to transition from screen 226 to roster screen 224.

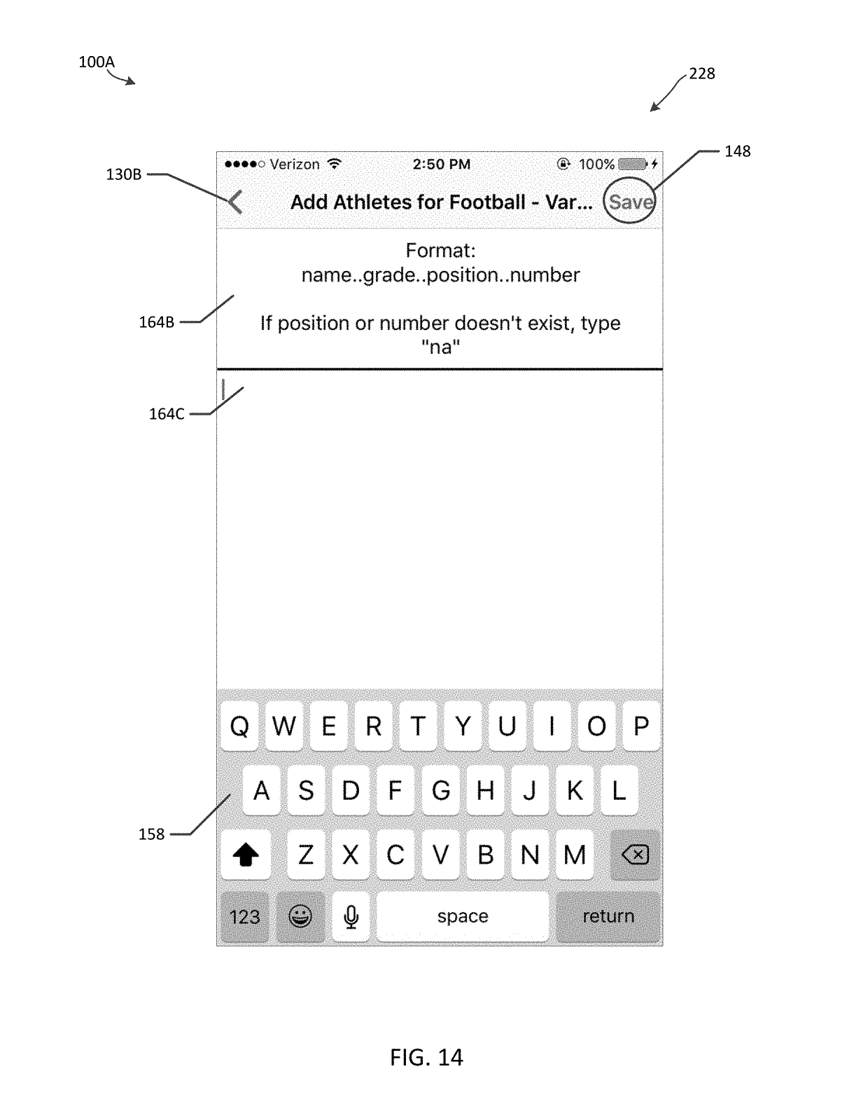

FIG. 14 shows an exemplary text entry screen 228 for inputting player information within program 100 according to an embodiment of the present disclosure. An AU may access screen 228 by selecting text entry feature 164A while screen 226 is displayed on the computing device. Screen 228 includes transition feature 130B, save feature 148, format information 164B, and input section 164C. Input section 164C allows an AU to utilize digital keyboard 158 associated with the computing device to input information/characteristics relating to a particular student athlete. As indicated by section 164B, the AU must abide by the format requirements displayed within format section 164B when entering the student athlete information within input section 164C. Once the athlete's information is inputted, the AU selects save feature 148 to save the inputted text based information. Tapping/engaging transition feature 130B causes program 100A to transition from screen 228 to player information input screen 226.

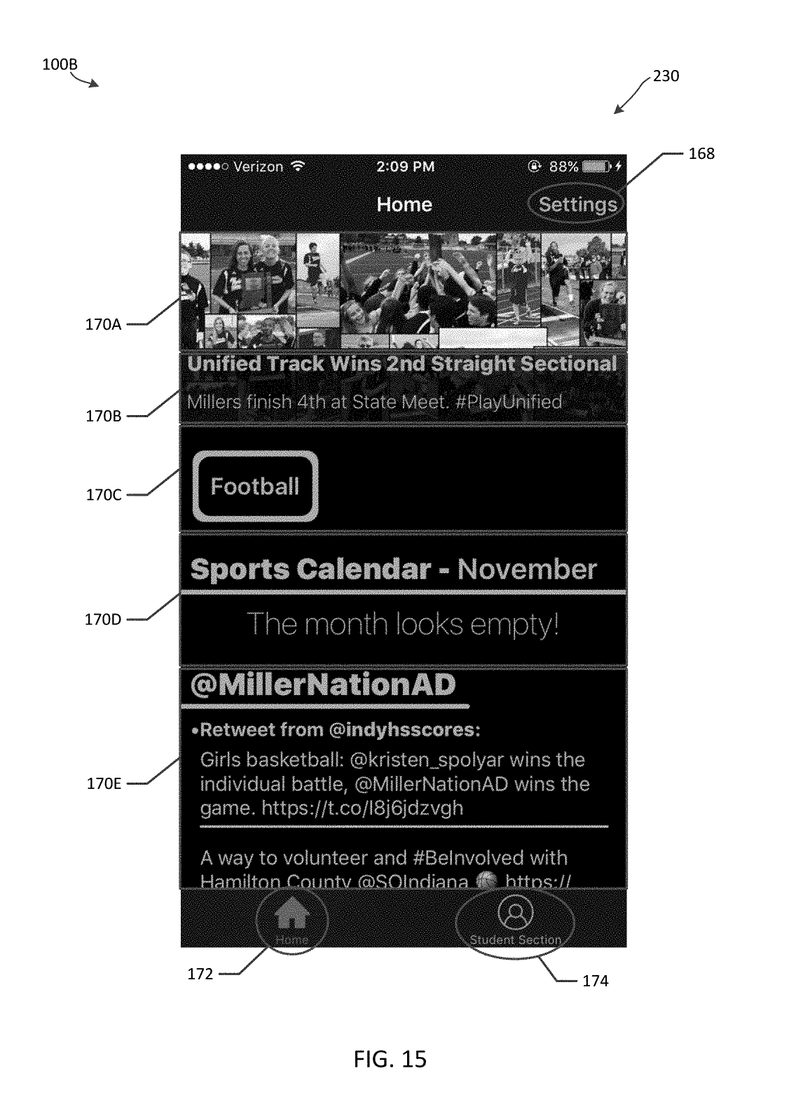

FIG. 15 shows an exemplary user specific home screen 230 for program 100 according to an embodiment of the present disclosure. As described in more detail herein below, FIGS. 15-20 are exemplary screens associated with program 100B which are viewable on an exemplary computing device. In one embodiment, a student user (hereinafter “SU”) may access screen 230 by selecting/tapping a digital icon (not shown) associated with program 100B from there smartphone or computing device. In one aspect of this embodiment, the digital icon associated with program 100B is accessible on the SU's smartphone or computing device based on the SU having downloaded program 100B from an exemplary online/internet based application store. Screen 230 includes settings 168, image display section 170A, updates section 170B, sports section 170C, sports calendar 170D, and social media section 170E. Screen 230 further includes home feature 172 and student section 174.

Image display section 170A is configured to display a plurality of digital images corresponding to one or more sports events and matches associated with program 100B. Likewise, updates section 170B includes text based updates that provide information associated with one or more sports events and matches associated with program 100B. In one embodiment, the information provided or displayed in section 170B shows the outcome of a particular high school sporting event, such as, the team that won the sporting event or whether a particular team has a consecutive win streak. Although only a single sport (i.e., football) is shown in the illustrative embodiment of FIG. 15, in alternative embodiments, sports section 170C may display a plurality of different sports, such as, football, basketball, and baseball. In one aspect of this embodiment, the plurality of different sports displayed in section 170C are user selectable such that tapping/selecting a particular sport causes program 100B to transition to a screen configured to display match information for the selected sport.

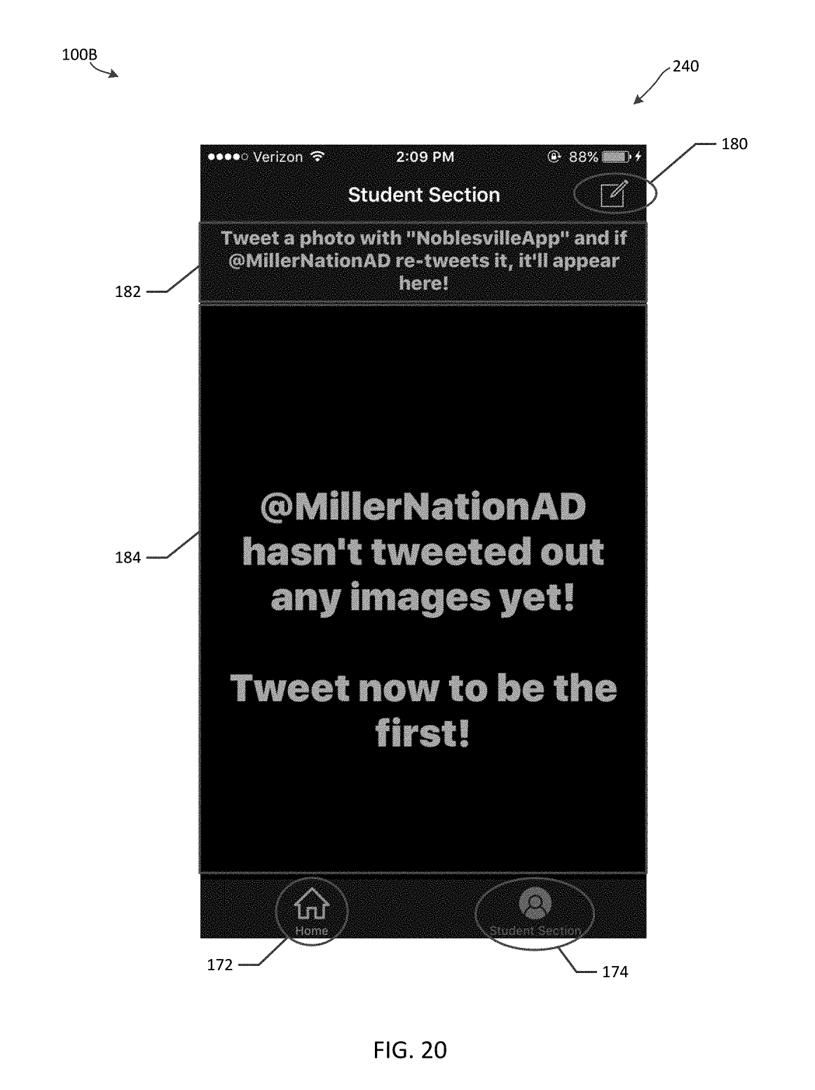

Sports calendar 170D may be configured to display one or more sporting events or matches scheduled to occur in a particular month. Additionally, as discussed briefly above, program 100B is generally configured to provide student athlete sporting event calendaring (e.g., via section 170D), player information and social media integration (e.g., via section 170E) for high schools in various geographic regions. In one embodiment, program 100B enables one or more SUs to communicate via social media application functionality integrated within program 100. In one aspect of this embodiment, social media application functions associated with Twitter® are integrated within program 100B. The Twitter social media application function enables one or more student users to share text based communications (e.g. tweets) and digital image files with other SUs that also have access to program 100B. Specifically, social media section 170E allows SUs to view communications such as tweets and digital image files shared by other SUs utilizing program 100B. Home feature 172 allows a SU to return to screen 230 when the user views another screen associated with program 100B and home feature 172 is viewable and selectable within that particular screen. Student section 174 will be described in more detail is the disclosed embodiment of FIG. 20.

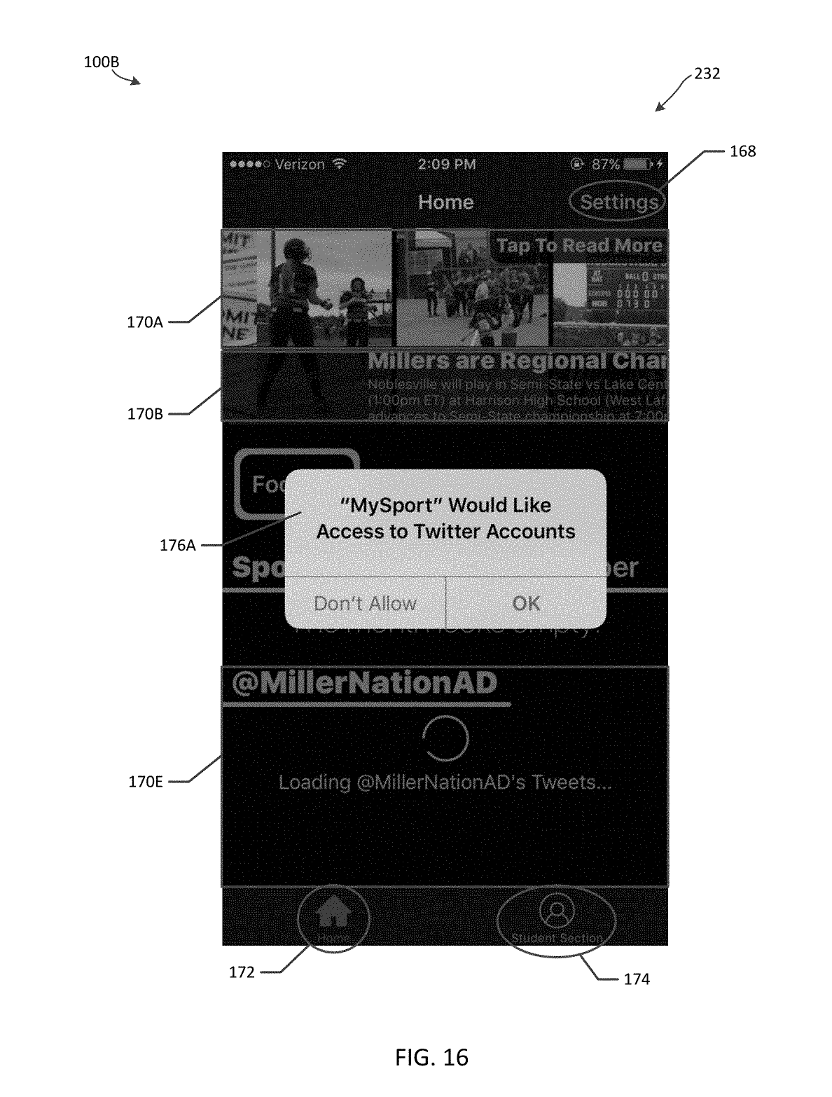

FIG. 16 shows an exemplary external application access request screen 232 for program 100 according to an embodiment of the present disclosure. Screen 232 includes access request feature 176A which indicates to a SU that program 100B (identified as “MySport” in the illustrative embodiment of FIG. 16) would like to access a twitter account owned by or associated with the SU. As shown in FIG. 16, the SU may grant program 100B access to their twitter account (e.g., by selecting “OK”) or, alternatively, the SU may not allow program 100B access to their twitter account (e.g., by selecting “Don't Allow”).

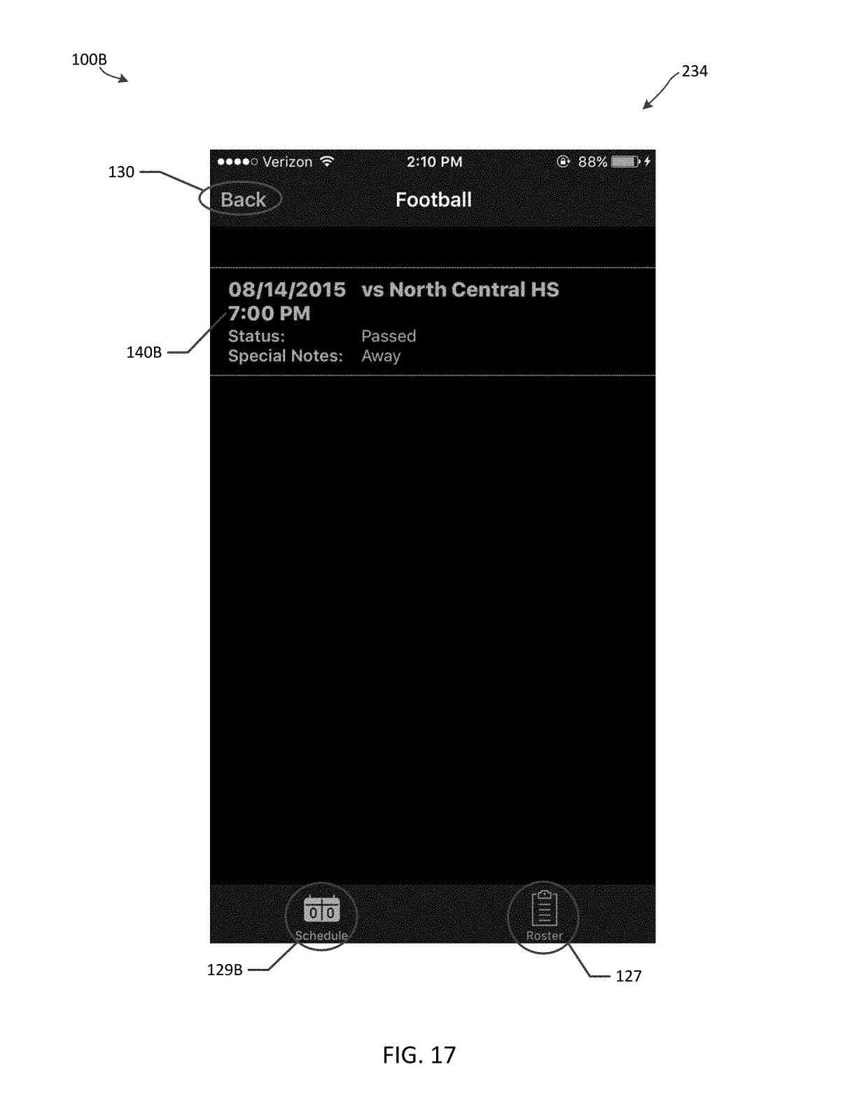

FIG. 17 shows an exemplary user specific school sports schedule screen 234 for program 100 according to an embodiment of the present disclosure. Screen 234 includes some of the same features as screen 216 described above with respect to an embodiment of program 100A. For example, screen 234 includes back feature 130, match information 140B, roster 127, and schedule 129B (related to matches 129A feature of program 100A). A SU may access screen 234 by selecting a particular sport (e.g., football) displayed in sport section 170C of home screen 172. In one embodiment, match information 140B includes school opponent (e.g. North Central HS), match start time (e.g. 7:00 PM), match status (e.g. Passed, Upcoming, Now, etc.), match special notes (e.g. Away). Roster 127 is a conventional player roster that includes individual player (student athlete) information for the two teams engaged in a particular sporting match. As shown in the illustrative embodiment of FIG. 17, in program 100B, schedule 129B shows one or more matches associated with a particular sports season. Back feature 130 with screen 234 causes program 100B to transition back to home screen 230.

As discussed briefly above, program 100 includes an editor application program 100A and a student application program 100B. Program 100A enables an exemplary AU to perform application edits by, for example, adding and/or removing one or more features or functions that are viewable and/or accessible within program 100B. Program 100B is generally configured such that a non-administrator user (e.g. a SU) can only view and access those program features and functions that are enabled by program 100A. Hence, because program 100B is configured only for a SU, program 100B is devoid of any application modifying features/functions such as edit feature 110 and add feature 116 (selectable via screen 216 of program 100A).

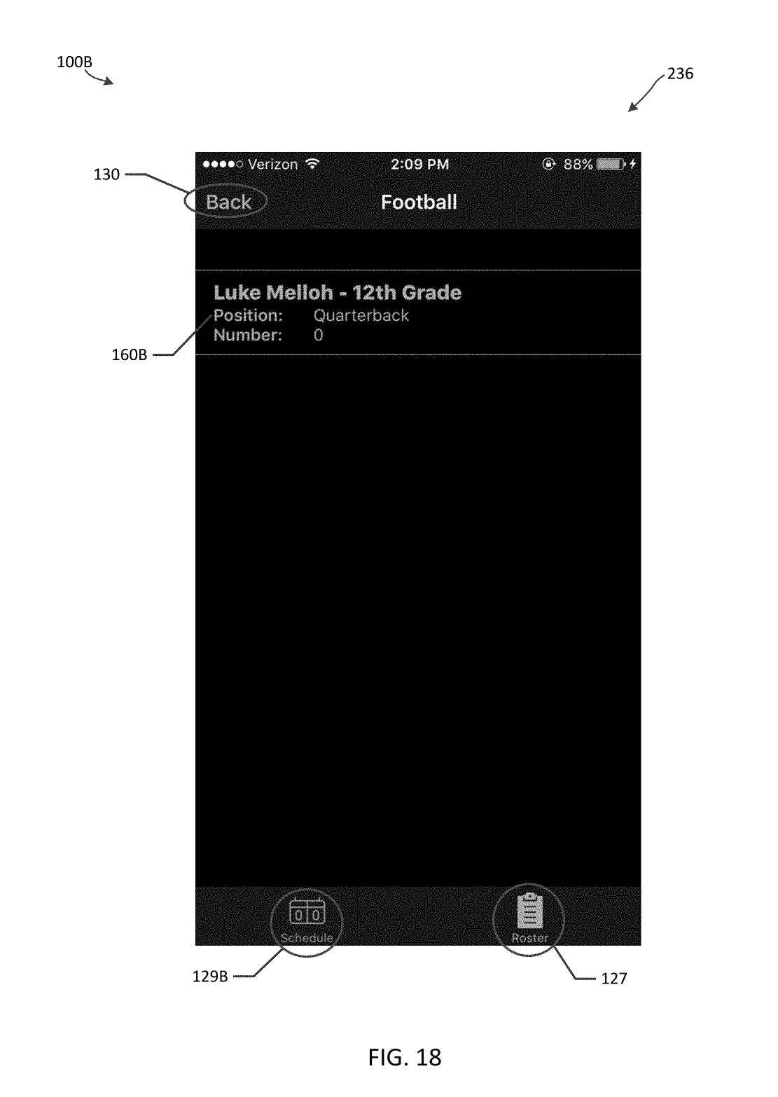

FIG. 18 shows an exemplary user specific roster screen 236 including individual player information viewable within program 100 according to an embodiment of the present disclosure. Screen 236 includes some of the same features as screen 224 described above with respect to an embodiment of program 100A. For example, screen 236 includes back feature 130, player information 140B, roster 127, and schedule 129B. A SU may access screen 236 by selecting roster 127 while screen 234 is displayed on the computing device. As shown in the embodiment of FIG. 18, player information 160B includes one or more characteristics of the student athlete such as the name of the athlete, an identifying number associated with the athlete, a sport position played by the athlete (e.g., Quarterback, Point Guard, Pitcher, etc.), and a high school academic year/grade of the athlete. In various embodiments, the identifying number associated with the athlete corresponds to the number displayed on a team uniform or jersey worn by the athlete when the athlete participates in an exemplary sports match or sporting event. In one embodiment, tapping/engaging schedule 129B causes program 100B to transition from roster screen 236 to schedule screen 234. Selecting back feature 130 when screen 236 is displayed causes program 100B to transition from schedule screen 236 to either home screen 230 or schedule screen 234.

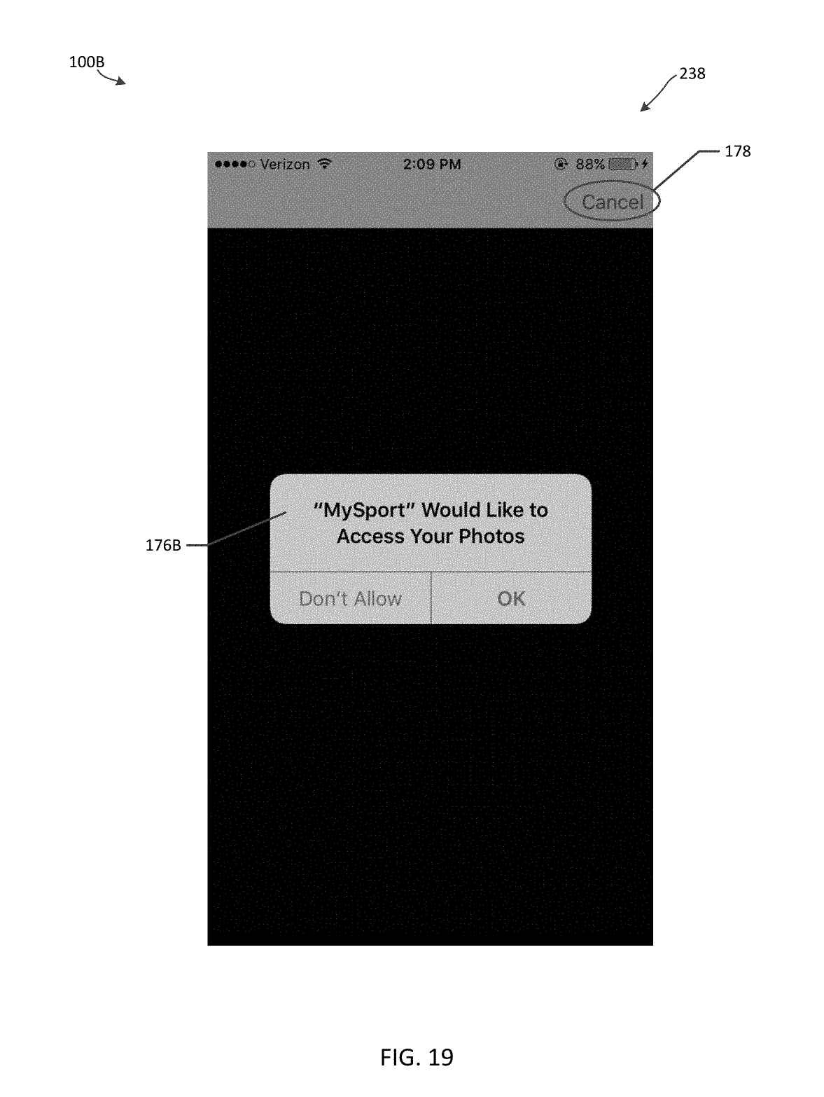

FIG. 19 shows an exemplary local data access request screen 238 for program 100 according to an embodiment of the present disclosure. Screen 238 includes access request feature 176B which indicates to a SU that program 100B (identified as “MySport” in the illustrative embodiment of FIG. 19) would like to access one or more photos (i.e., digital image files) that are stored in local memory within the SU's computing device or smartphone. As shown in FIG. 19, the SU may grant program 100B access to their photos/image files (e.g., by selecting “OK”) or, alternatively, the SU may not allow program 100B access to their photos/image files (e.g., by selecting “Don't Allow”).

FIG. 20 shows an exemplary student specific social media integration screen 240 for program 100 according to an embodiment of the present disclosure. A SU may access screen 240 by selecting student section 174 while home screen 230 is displayed on the exemplary computing device/smartphone. Screen 240 includes tweet input 180, information section 182, twitter information section 184, home feature 172, and student section 174. In one embodiment, the twitter information provided or displayed in section 184 may show images and text tweeted by a SU via there the SU's personal twitter account. As indicated above, program 100B includes social media application functions associated with Twitter® that are integrated within program 100B. Tweet input 180 enables one or more student users to share text based communications (e.g. tweets) and digital image files with other SUs that also have access to program 100B. In one embodiment, a SU may send a tweet, including an photo/image file, from their personal twitter account (assuming the SU has granted program 100B access, see description of FIG. 16 above) via program 100B to a twitter handle associated with a particular high school. If that particular high school has a user account associated with program 100B and/or is logged into program 100B, then the high school may retweet the twitter messages sent from a particular SU such that a plurality of SUs utilizing program 100B may view the SU's twitter message within twitter information section 184. Lastly, selecting home screen 230 when screen 240 is displayed causes program 100B to transition from social media integration screen 240 to home screen 230.

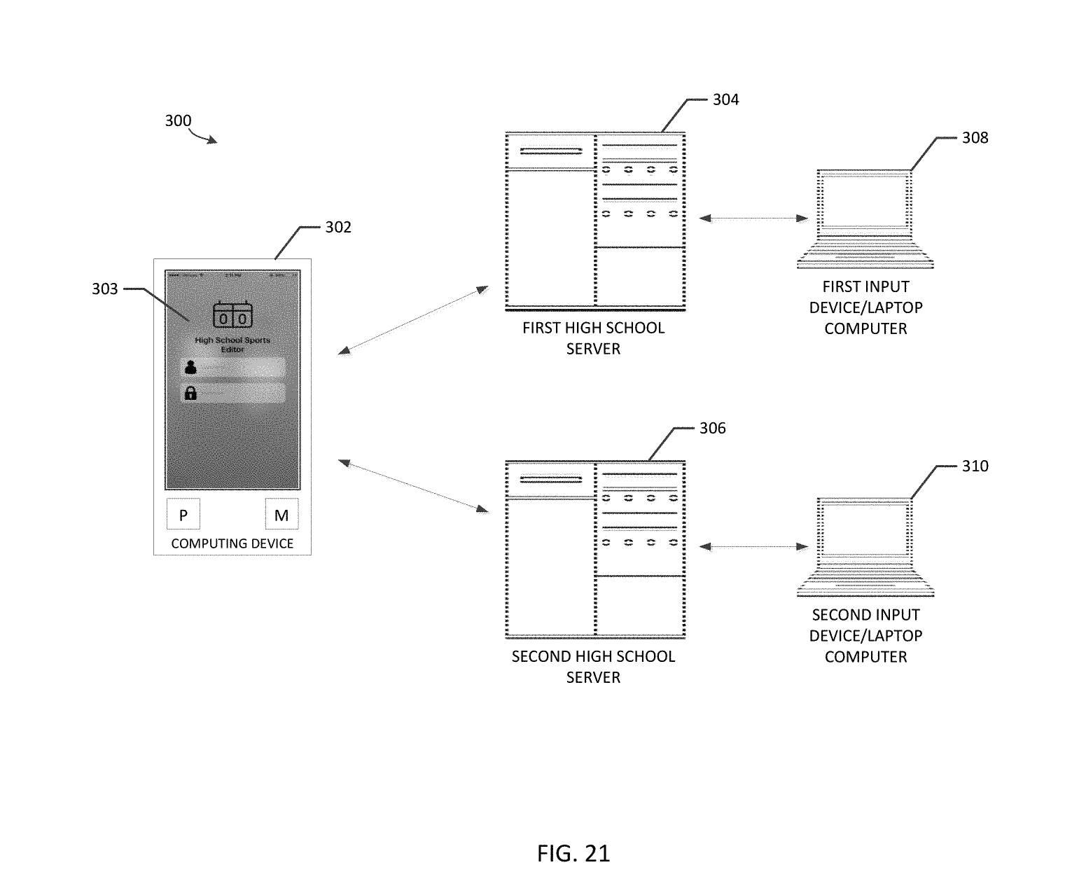

FIG. 21 shows a block diagram of an exemplary network 300 for exchanging data communications between at least one computing device and at least one server according to an embodiment of the present disclosure. Network 300 generally includes computing device 302, display screen 303, first server 304, second server 306, first input device 308, and second input device 310. Computing device 302 generally includes at least one processor (P) and at least one memory (M). Likewise first and second servers 304, 306 as well as first and second input devices 308, 310 may also include one or more processors (not shown) and one or more memory modules (not shown). As discussed above, the plurality of screens associated with program 100 are representative of viewable features and functions accessible on display 303 of computing device 302. As such, device 302 may have executable code for program 100 stored within device memory (M) and processor (P) may access that code to execute and/or initiate operation of program 100.

As discussed briefly above, program 100 is generally configured to provide student athlete sporting event calendaring, player/athlete information and social media integration for high schools in various geographic regions. In one embodiment, program 100 provides sporting event calendaring, sporting event scoring and player/athlete information for a plurality of high schools in an exemplary state such as Indiana. In various embodiments, data/information related to high school sports events such as event date, event time and event location may be available and accessible from one of first server 304 and second server 306. Similarly, data corresponding to player information for a particular high school may also be available and accessible from one of first server 304 and second server 306. Specifically, first server 304 may be disposed in or associated with a first high school and may include a variety of data corresponding to one or more sports events in which athletic teams assigned to the first high school will be participating. Likewise, second server 306 may be disposed in or associated with a second high school and may include a variety of data corresponding to one or more sports events in which athletic teams assigned to the second high school will be participating.

In the aforementioned embodiments of the present disclosure, an AU manually inputs or adds data, via application program 100A, that is then used and displayed by program 100B. For example, after adding one or more high schools via program 100A, an AU may then add a plurality of information relating to various sports events for each high school. In one embodiment of the present disclosure, network 300 enables at least partially automated inputting/adding, to program 100A, of various data relating to sports events for a particular high school. As shown in the illustrative embodiment of FIG. 21, computing device 302 may be configured to establish a data communications link with first and second servers 304, 306. The communications coupling/link between device 302 and first and second servers 304, 306 enables device 302 to automatically retrieve/download sports event information for a plurality of high school sports events scheduled to occur during a particular sports season. In one embodiment, first and second servers 304, 306 may each include dates, times, and locations for a high school football game and program 100A causes device 302 to download the sports event information and display (via display 303) the information to a SU running program 100B on device 302. Moreover, first and second servers 304, 306 may each include individual player information including player name, player position, player jersey/identification number, and player statistics (e.g., points, touchdowns, tackles, wins, rushing yards, rebounds, home-runs, etc.). Program 100A may also cause device 302 to download the individual player information and display the information (via display 303) to the SU running 100B on device 302. In one embodiment, first input device 308 is used to input the above described sports and player information to a memory of server 304 for storage therein and second input device 310 is used to input the above described sports and player information to a memory of server 306 for storage therein.

In the foregoing specification, specific embodiments of the present disclosure have been described. However, one of ordinary skill in the art will appreciate that various modifications and changes can be made without departing from the scope of the disclosure as set forth in the claims below. Accordingly, the specification and figures are to be regarded in an illustrative rather than a restrictive sense. The benefits, advantages, solutions to problems, and any element(s) that may cause any benefit, advantage, or solution to occur or become more pronounced are not to be construed as critical, required, or essential features or elements of any or all the claims. The invention is defined solely by the appended claims including any amendments made during the pendency of this application and all equivalents of those claims as issued. No claim element herein is to be construed under the provisions of 35 U.S.C. 112(f) unless the element is expressly recited using the phrase “means for.”

1. A method, comprising:
providing, by a computing device, a user interface viewable on a display of the computing device, the user interface being configured to receive data corresponding to one or more high school athletic events;
providing, via the user interface, data to a first application stored in a memory of the computing device, the data corresponding to one of a high school athletic event, an athlete associated with the high school athletic event, and a characteristic of the athlete;
accessing, via the user interface, a second application that uses the data provided to the first application, the second application being stored in the memory of the computing device;
accessing, via the user interface and the second application, data associated with the one or more high school athletic events, the data indicating one or more characteristics of the athlete and indicating a plurality of characteristics corresponding to the high school athletic event.

2. The method of claim 1, wherein the first application is an administrator program and the second application is a student user program.

3. The method of claim 1, wherein the one or more characteristics of the athlete includes the name of the athlete, an identifying number associated with the athlete, a sport position played by the athlete, and a high school academic year of the athlete.

4. The method of claim 1, wherein the plurality of characteristics of the high school athletic event includes a real-time score associated with the high school athletic event, a location of the high school athletic event and an outcome of the high school athletic event.

5. A computing device comprising a processor configured to:
provide a user interface viewable on a display of the computing device, the user interface being configured to receive input data corresponding to one or more high school athletic events;
based on the received input data, provide first data to a first application stored in a memory of the computing device, the first data corresponding to one of a high school athletic event, an athlete associated with the high school athletic event, and a characteristic of the athlete;
access, via the user interface, a second application that uses the first data provided to the first application, the second application being stored in the memory of the computing device;
access, via the user interface and the second application, second data associated with the one or more high school athletic events, the second data based on the first data and indicating one or more characteristics of the athlete and indicating a plurality of characteristics corresponding to the high school athletic event.

6. The computing device of claim 5 wherein the processor is further configured to provide text based communications with at least one other computing device.

7. The computing device of claim 5 wherein the processor is further configured to, via the first application, add a feature to the second application.

8. The computing device of claim 7 wherein the processor is further configured to detect a selection of the added feature via the user interface.

9. The computing device of claim 7 wherein the processor is configured to add the feature to the second application by adding one or more sports seasons to the second application.

10. The computing device of claim 8 wherein the processor is configured to add to the second application one or more schools to the added one or more sports seasons.

11. The computing device of claim 5 wherein the processor is further configured to, via the first application, remove a feature of the second application.

12. The computing device of claim 5 wherein the processor is configured to receive the input data by establishing a data communication link to a webpage.

13. The computing device of claim 5 further comprising providing, via the user interface, scoring information for one or more high school sports.

14. A computing device comprising:
one or more processors; and
a memory operably coupled to the processor and comprising executable instructions that when executed by the one or more processors cause the one or more processors to:
provide a user interface viewable on a display of the computing device, the user interface being configured to receive input data corresponding to one or more high school athletic events;
based on the received input data, provide first data to a first application stored in a memory of the computing device, the first data corresponding to one of a high school athletic event, an athlete associated with the high school athletic event, and a characteristic of the athlete;
access, via the user interface, a second application that uses the first data provided to the first application, the second application being stored in the memory of the computing device;
access, via the user interface and the second application, second data associated with the one or more high school athletic events, the second data based on the first data and indicating one or more characteristics of the athlete and indicating a plurality of characteristics corresponding to the high school athletic event.

15. The computing device of claim 14 wherein the memory further comprises executable instructions that when executed by the one or more processors cause the one or more processors to provide text based communications with at least one other computing device.

16. The computing device of claim 14 wherein the memory further comprises executable instructions that when the executed by the one or more processors cause the one or more processors to, via the first application, add a feature to the second application.

17. The computing device of claim 16 wherein the memory further comprises executable instructions that when the executed by the one or more processors cause the one or more processors to detect a selection of the added feature via the user interface.

18. The computing device of claim 16 wherein the memory further comprises executable instructions that when the executed by the one or more processors cause the one or more processors to add the feature to the second application by adding one or more sports seasons to the second application.

19. The computing device of claim 14 wherein the memory further comprises executable instructions that when the executed by the one or more processors cause the one or more processors to, via the first application, remove a feature of the second application.

20. The computing device of claim 14 wherein the memory further comprises executable instructions that when the executed by the one or more processors cause the one or more processors to receive the input data by establishing a data communication link to a webpage.
